(19) United States
(12) Patent Application Publication
(10) Pub. No.: US 2011/0150060 A1
(43) Pub. Date: Jun. 23, 2011

(54) Voltage Margin Monitoring for an ADC-Based Serializer/Deserializer in Mission Mode

(75) Inventors: Dawei Huang, San Diego, CA (US); Deqiang Song, San Diego, CA (US); Drew G. Doblar, San Jose, CA (US); Agustin Del Alamo, San Diego, CA (US)

(73) Assignee: SUN MICROSYSTEMS, INC., Santa Clara, CA (US)

(21) Appl. No.: 12/645,612

(22) Filed: Dec. 23, 2009

(51) Int. Cl. H04B 17/00; H04L 27/01

(52) U.S. Cl. 375/224; 375/233

(57) ABSTRACT

Various embodiments herein include one or more of systems, methods, software, and/or data structures to determine voltage margin for a high-speed serial data link. Advantageously, the margin determination may be made during normal operation of the data link (“mission mode”) such that the performance of the data link is not affected by the voltage margin measurements. That is, the margin measurements may be performed “on line” rather than “off line.” To facilitate the voltage margin measurement, a plurality of digital samples from an analog to digital converter (ADC) may be evaluated to determine the most probable bit values (i.e., digital 1's and 0's) that are represented by the digital samples. Then, a method may be used to remove or compensate for ISI effects from one or more of the digital samples, thereby providing an accurate representation of the voltage margin present in a data link. Subsequently, the voltage margin may be periodically monitored over time to detect degradation of the data link.

### BACKGROUND

In many of today's integrated circuits (IC's), serializer/deserializer (SerDes) circuits are implemented to enable the IC's to exchange information with each other and with other components at very high data rates. The SerDes circuits generally include a transmitter and a receiver. Typically, information is sent from a transmitter on one IC to a receiver on another IC through a series of analog pulses. Specifically, to send a digital bit of information, a transmitter determines whether the bit that it wants to send is a digital 1 or a digital 0. If the bit is a digital 1, the transmitter generates an analog signal (which may be made up of a single signal or a pair of differential signals) having a positive voltage. If the bit is a digital 0, the transmitter generates an analog signal having a negative voltage. After generating the analog signal, the transmitter sends the analog signal as a pulse having a certain duration to the receiver along a communications link. Upon receiving the analog signal, the receiver determines whether the analog signal has a positive voltage or a negative voltage. If the voltage is positive, the receiver determines that the analog signal represents a digital 1. If the voltage is negative, the receiver determines that the analog signal represents a digital 0. In this manner, the transmitter is able to provide digital information to the receiver using analog signals.

Ideally, the receiver receives analog pulses that closely resemble the analog pulses that were sent by the transmitter. Unfortunately, due to a pulse response effect that is experienced at high data rates, this ideal cannot be achieved. In fact, the analog signal that is received by the receiver often differs from the pulse that was sent by the transmitter by such a degree that it is often difficult for the receiver to determine whether the received analog signal represents a digital 1 or a digital 0.

To elaborate upon the concept of a pulse response, reference will be made to the sample pulse response shown in FIG. 1. FIG. 1 shows an example of what may be received by a receiver in response to a single positive-voltage pulse (representing a digital 1) sent by the transmitter. In the example shown in FIG. 1, the pulse is sent by the transmitter in time interval x−4 and received by the receiver four time intervals later beginning with time interval x. Notice that even though the transmitter sent a pulse lasting only a single time interval, the receiver does not receive that pulse in just a single time interval. Instead, the receiver receives an analog signal that lasts for several time intervals. During time interval x, the received signal has a magnitude of h0. During the next time interval (interval x+1), the received signal still has a magnitude of h1. During the next several time intervals, the received signal still has magnitudes of h2, h3, h4, and so on. Thus, even though the transmitter sent a pulse lasting only one time interval, the receiver receives a signal that lasts for many time intervals.

Because of this pulse response effect, a pulse sent in one time interval affects pulses sent in future time intervals. To illustrate, suppose that the transmitter sends another positive-voltage pulse in time interval x−3, and that this pulse is received by the receiver beginning in time interval x+1. During time interval x+1, the receiver would sense the h0 voltage of the pulse sent in time interval x−3. The receiver would also sense the h1 voltage of the pulse previously sent in time interval x−4. Suppose further that the transmitter sends another positive-voltage pulse in time interval x−2, and that this pulse is received by the receiver beginning in time interval x+2. During time interval x+2, the receiver would sense the h0 voltage of the pulse sent in time interval x−2. The receiver would also sense the h1 voltage of the pulse previously sent in time interval x−3. In addition, the receiver would sense the h2 voltage of the pulse previously sent in time interval x−4. Thus, the voltage sensed by the receiver at time interval x+2 is an accumulation of the effects of the pulses sent at time intervals x−4, x−3, and x−2 (and even pulses sent at time intervals before x−4). As this example shows, when the receiver senses a voltage during a time interval, it does not sense the effect of just one pulse but the accumulation of the effects of multiple pulses. This distortion may generally be referred to as “intersymbol interference” (ISI). Severe ISI problems may prevent receivers from distinguishing symbols and consequently disrupts the integrity of received signals in a communications link.

FIG. 1 shows the pulse response for a single positive-voltage pulse. The pulse response for a single negative-voltage pulse (representing a digital 0) is shown in FIG. 2. Notice that the pulse response of FIG. 2 is similar to the pulse response of FIG. 1 except that the voltages are negative instead of positive. Thus, as shown by FIGS. 1 and 2, the effect that a pulse has on future pulses will depend on whether that pulse is a positive-voltage pulse (representing a digital 1) or a negative-voltage pulse (representing a digital 0). If a pulse is a positive-voltage pulse, it will add to the voltages of future pulses. Conversely, if the pulse is a negative-voltage pulse, it will subtract from the voltages of future pulses.

As can be seen from the above discussion, a pulse response can significantly affect the signals that are received by a receiver. Thus, it is highly desirable in many implementations to ascertain the pulse response effect that is experienced by a receiver. Armed with knowledge of the pulse response, it may be possible to compensate for its effects. It may also be possible to use the pulse response information to adjust the parameters of the transmitter and/or receiver and perhaps even other components to improve the overall performance of the transmission/reception process. These and other uses of the pulse response information are possible. A point to note is that a pulse response is a characterization of the link performance of the communications link to which a receiver is coupled. Because each receiver is coupled to a different communications link, each receiver may and most likely will experience a different pulse response effect. Thus, a pulse response is determined on a per receiver/communications link basis.

A pulse response for a receiver/communications link may be determined by sending a set of predetermined analog pulses (representing a predetermined bit pattern) from a transmitter to a receiver along a communications link, and capturing a waveform of the signals actually received by the receiver. Once the waveform is captured, it can be processed and compared with an ideal waveform to derive a pulse response for the receiver/communications link. The difficult part of this process, however, is capturing the waveform in a practical and feasible manner.

One possible approach to capturing the waveform is to implement sufficient sampling and storage components on each receiver to enable the receiver to capture an oversampled waveform for the signals received by the receiver. To illustrate how this may be done, suppose that a predetermined 128 bit pattern is sent by a transmitter to a receiver over 128 time intervals. Suppose further that it is desirable for the receiver to oversample the signals received by the receiver 48 times (i.e. take 48 samples of the incoming signals per time interval). To capture such a waveform, the receiver would need a sampling clock signal that is 48 times faster than the incoming data clock. During each time interval, the receiver would sample the analog signal received during that time interval 48 times. For each sample, the receiver would sense an analog signal and convert it into a corresponding x-bit (e.g. 4-bit) digital value. Each x-bit digital value would be stored in a register. At the end of the 128 time intervals, the receiver will have captured all of the sample values needed to form an oversampled waveform for the incoming signals.

A problem with this approach, however, is that it is quite resource intensive. In order to capture the entire oversampled waveform, the receiver would need 48×128 or 6,144 x-bit registers just to store all of the digital sample values. In addition, the receiver would need to have components for implementing the sampling and storage functions. These components and storage consume a significant amount of chip space. In a large scale IC (e.g. a microprocessor), which can comprise a very large number of receivers, chip space is precious, and in most implementations, it is not practical for each receiver to consume a large amount of chip space. Because of these and other practical considerations, this approach to capturing an oversampled waveform cannot be feasibly implemented in most applications.

One technique for reducing the effect of ISI is to use an adaptive equalizer such as a decision feedback equalizer (DFE). A DFE may be operative to compensate for ISI by utilizing digital filtering techniques. For example, when a pulse response for a communication link is known, a DFE may include a plurality of taps (e.g., 2 taps, 5 taps, or the like) that are used to cancel the effects (e.g., reduce the effects from h1, h2, h3, etc.) of previously sent bits on a present bit. The taps or coefficients for a DFE may be generated using any number of adaptation processes, and may be implemented in any suitable manner.

The importance of accurate data reception motivates communication link designers to design systems that are able to tolerate ISI and other types of noise. One quality characteristic that may be used is referred to as voltage margin or simply “margin.” Voltage margin characterizes the range of voltage and timing values for which a given receiver will properly determine input signals. That is, the degree to which the voltage and time can vary without introducing error is termed the “margin” for the communications link.

### SUMMARY

Various embodiments herein include one or more of systems, methods, software, and/or data structures to determine voltage margin for a high-speed serial data link. Advantageously, the margin determination may be made during normal operation of the data link (“mission mode”) such that the performance of the data link is not affected by the voltage margin measurements. That is, the margin measurements may be performed “on line” rather than “off line.” To facilitate the voltage margin measurement, a plurality of digital samples from an analog to digital converter (ADC) may be evaluated to determine the most probable bit values (i.e., digital 1's and 0's) that are represented by the digital samples. Then, a method may be used to remove or compensate for ISI effects from one or more of the digital samples, thereby providing an accurate representation of the voltage margin present in a data link. Subsequently, the voltage margin may be periodically monitored over time to detect degradation of the data link.

According to a first aspect, a computer-implemented method for measuring voltage margin in a serial communications link is provided. The method may include receiving a plurality of ordered digital values from an analog to digital converter (ADC) of a receiver, each digital value corresponding to a voltage level sampled by the ADC at a time interval that corresponds to a symbol sent by a transmitter. Further, the method may include determining bit values for each of the digital values, and determining intersymbol interference (ISI) information for at least one of the determined bit values. Once the bit values and ISI information has been determined, the method includes calculating voltage margin for the at least one of the bit values using the digital value from the ADC corresponding to the bit value and subtracting the determined ISI for the bit value.

According to a second aspect, a computer system is provided that includes a processor and a data storage coupled to the processor. The data storage may store a voltage margin monitoring module that is operative to be executed by the processor to receive a plurality of ordered digital values from an analog to digital converter (ADC) of a receiver, each digital value corresponding to a voltage level sampled by the ADC at a time interval that corresponds to a symbol sent by a transmitter. The voltage margin monitoring module may further be operative to be executed by the processor to determine bit values for each of the digital values by comparing the digital values to a reference value, and to determine intersymbol interference (ISI) information for at least one of the determined bit values. Further, the voltage margin monitoring module may be operative to be executed by the processor to calculate voltage margin for the at least one of the bit values using the digital value from the ADC corresponding to the bit value and subtracting the determined ISI for the bit value.

According to a third aspect, a computer readable medium is provided. The computer readable medium may include instructions, which when processed by a computer, cause the computer to receive a plurality of ordered digital values from an analog to digital converter (ADC) of a receiver, each digital value corresponding to a voltage level sampled by the ADC at a time interval that corresponds to a symbol sent by a transmitter. The instructions may also be operative to cause a computer to determine bit values for each of the digital values, and determine intersymbol interference (ISI) information for at least one of the determined bit values. In addition, the instructions may also be operative to cause a computer to calculate voltage margin for the at least one of the bit values using the digital value from the ADC corresponding to the bit value and subtracting the determined ISI for the bit value.

In addition to the exemplary aspects and embodiments described above, further aspects and embodiments will become apparent by reference to the drawings and by study of the following descriptions.

### BRIEF DESCRIPTION OF THE DRAWINGS

FIG. 1 shows a sample pulse response for a positive-voltage pulse.

FIG. 2 shows a sample pulse response for a negative-voltage pulse.

FIG. 3 shows a sample eye diagram representing input signals to an exemplary receiver.

FIG. 4 shows a block diagram of a system in which one embodiment may be implemented.

FIG. 5 shows a block diagram of an exemplary receiver.

FIG. 6 shows a block diagram of an exemplary output determination module.

FIG. 7 shows a flow diagram of a method for calculating voltage margin for a receiver.

FIG. 8 shows another flow diagram of a method for calculating voltage margin for a receiver.

FIG. 9 illustrates a table of bit values and is provided to demonstrate an example implementation of the voltage margin calculation method shown in FIG. 8.

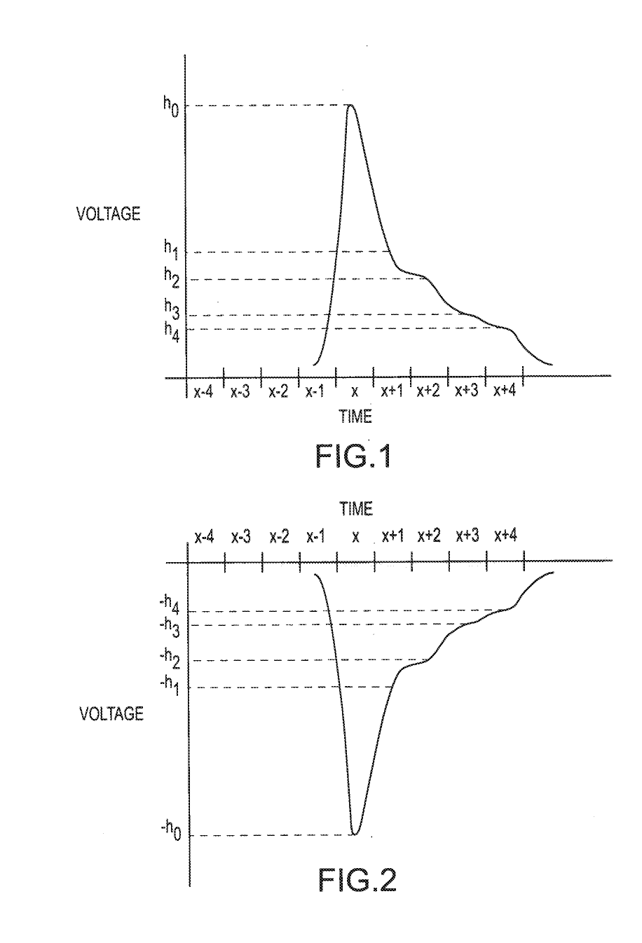

### DETAILED DESCRIPTION

Various embodiments herein include one or more of systems, methods, software, and/or data structures to determine voltage margin for a high-speed serial data link. Advantageously, the margin determination may be made during normal operation of the data link (“mission mode”) such that the performance of the data link is not affected by the voltage margin measurements. That is, the margin measurements may be performed “on line” rather than “off line.” To facilitate the voltage margin measurement, a plurality of digital samples from an analog to digital converter (ADC) may be evaluated to determine the most probable bit values (i.e., digital 1's and 0's) that are represented by the digital samples. Then, a method may be used to remove or compensate for ISI effects from one or more of the digital samples, thereby providing an accurate representation of the voltage margin present in a data link. Subsequently, the voltage margin may be periodically monitored over time to detect degradation of the data link.

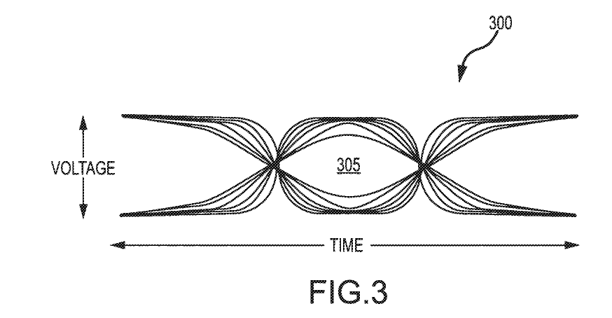

FIG. 3 illustrates a simplified eye diagram 300 for a serial data link that may be provided to a receiver. The eye diagram 300 is graphed in two dimensions, voltage and time. The area of the eye 305 represents a range of reference voltages and timing parameters with which data symbols (i.e., analog pulses representing digital 1's and 0's) may be captured by a receiver without introducing an error. As can be appreciated, the larger the eye 305, the more margin present in the system. Often, system designers desire to have the ability to measure the margin of a data link so that performance may be measured, problems may be detected, and the like. It will be appreciated that the simplified eye diagr

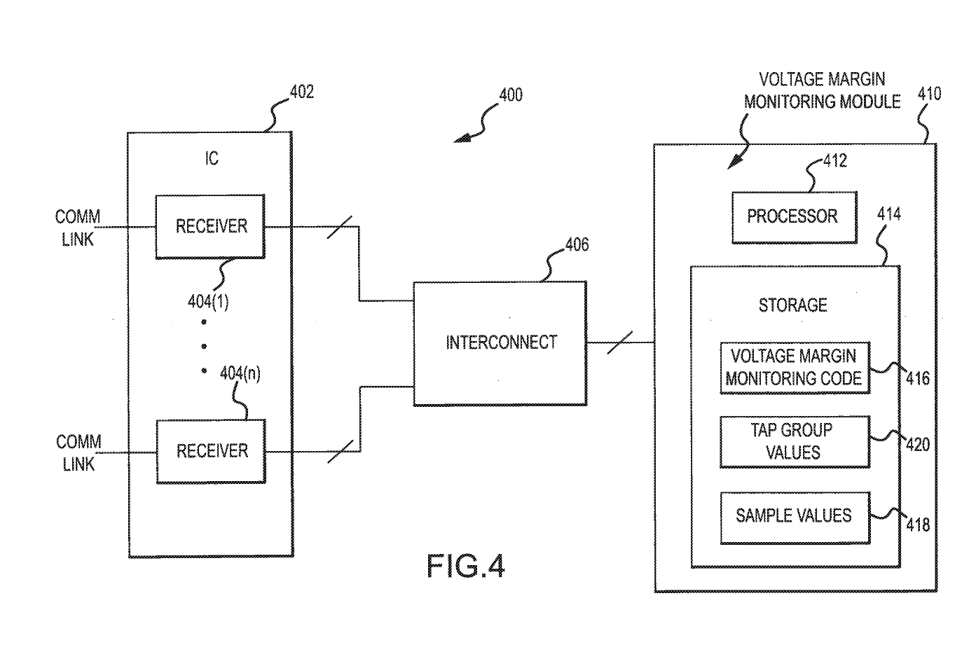

With reference to FIG. 4, there is shown a block diagram of a system 400 in which one embodiment may be implemented. As shown, system 400 includes an integrated circuit (IC) 402, an interconnect 406, and a voltage margin monitoring module (VMMM) 410. For the sake of simplicity, only one IC 402 is shown; however, it is noted that the VMMM 410 may be used to service any number of IC's.

As shown in FIG. 4, the IC 402 comprises a plurality of receivers 404(1)-404(n). Each receiver 404 is coupled to a corresponding communications link for receiving incoming signals sent by a corresponding transmitter (not shown). Each receiver 404 is also coupled to the interconnect 406 to enable the receiver 404 to interact with the VMMM 410. For purposes of the present invention, the interconnect 406 may be any type of interconnect (e.g. switches, multiplexers/demultiplexers, crossbar interconnect, wires, etc.) that is capable of selectively coupling each of the receivers 404 to the VMMM 410. When coupled to a receiver 404, the VMMM 410 interacts with that receiver to determine and/or monitor the voltage margin for that receiver. The voltage margin may then be used to detect degradation in communication links coupled to the receiver. For example, the voltage margin may be analyzed over time using statistical processing to detect potential problems with the receiver and/or communication link.

In one embodiment, the VMMM 410 is an off-chip component. That is, the VMMM 410 is not implemented on the same chip as the IC 402. By moving the voltage margin measurement capability off-chip, the resources required to be implemented on the receivers 404 may be minimized. This in turn enables the chip space consumed by each receiver 404 to be minimized. Despite the decreased chip space, each receiver 404 may still be able to interact with the VMMM 410. Thus, with this arrangement, it is possible to achieve a relatively small consumption of chip space by the receivers and measurement of voltage margin for the receivers.

In one embodiment, the VMMM 410 includes a processor 412 (or a plurality of processors) and a storage 414. The processor 412 may be a service processor that is already present in many large scale systems. If the processor 412 is a service processor, then the voltage margin determination may be achieved without adding any hardware to the system. The processor 412 may execute a set of voltage margin monitoring code 416 stored in the storage 414. Under control of the voltage margin monitoring code 416, the processor 412 may perform the voltage margin monitoring operations that will be described in later sections. In addition to being used to store the voltage margin monitoring code 416, the storage 414 may also be used to store sample values 418 (e.g., ADC sample values) that are received from the receivers 404. Further, the storage 414 may be operative to store tap group values 420 for an unrolled decision feedback equalizer (DFE) that may be used in the voltage margin monitoring, as is described further below.

In the embodiment described above, the functionality of the VMMM 410 may be realized using software (i.e. by having processor 412 execute code 416). As an alternative, the functionality of the VMMM 410 may also be realized in hardware, for example, by way of an ASIC or a set of hardwired logic components. This and other alternative implementations of the VMMM 410 are within the scope of the present embodiments.

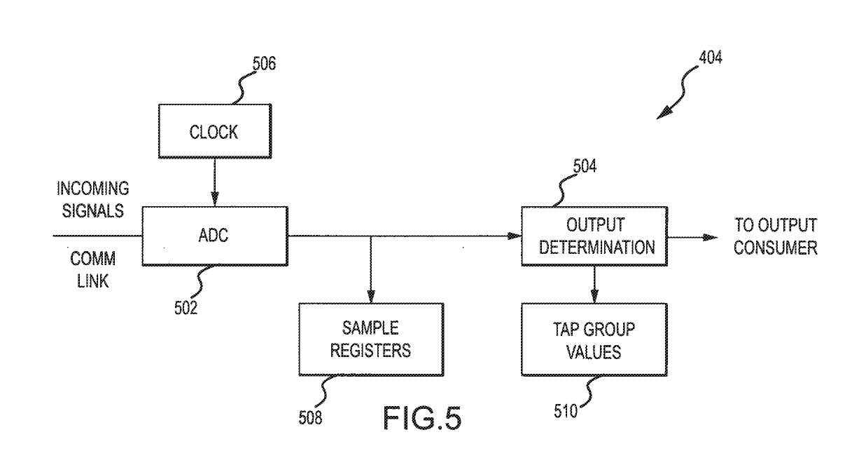

With reference to FIG. 5, there is shown a more detailed block diagram for a receiver 404 in accordance with one or more embodiments. Any or all of the receivers 404(1)-404(n) in IC 402 shown in FIG. 4 may take the form of the receiver 404 shown in FIG. 5. As shown, the receiver 404 may comprise an analog-to-digital converter (ADC) 502, an output determination circuit 504, a clock circuit 506 (or sampling control circuit), a set of sample registers 508, and storage that holds tap group values 510 from the output determination circuit 508.

The ADC 502 may be coupled to a communications link to receive incoming analog signals. In response to a sampling clock signal from the clock circuit 506, the ADC 502 may sample an incoming analog signal at a particular sampling point, and convert that analog signal into a representative x-bit digital value (where x may be any integer greater than one, e.g. 4, 8, or the like). The digital value (i.e. the sample value) may then be passed to the output determination circuit 504, which processes the digital value to determine whether the received analog signal represented by the digital value was a digital 1 or a digital 0. In making this determination, the output determination circuit 504 may implement some compensation techniques to compensate for the effects of previously sent signals (e.g., post-cursors h1, h2, h3, and the like). For example, the output determination circuit 504 may include a feed forward equalizer (FFE) and/or a decision feedback equalizer (DFE). After this determination is made, the output determination circuit 504 may output an appropriate digital bit (digital 1 or 0), which is provided to an output consumer. In this manner, the receiver 404 is able to receive an analog signal (or pulse), and turn it into a representative digital output bit.

As noted above, the clock circuit 506 provides a sampling clock signal to the ADC 502. It is this sampling clock signal that determines at what point within a time interval the ADC 502 samples an incoming analog signal. The sampling clock signal may cause the ADC 502 to sample an analog signal at the beginning of the time interval, at the end of the time interval, or at some point in between. In one embodiment, the sampling point may be adjusted based upon a jog control signal. This jog control signal may cause the sampling point to be jogged or moved by a certain amount to a different sampling point.

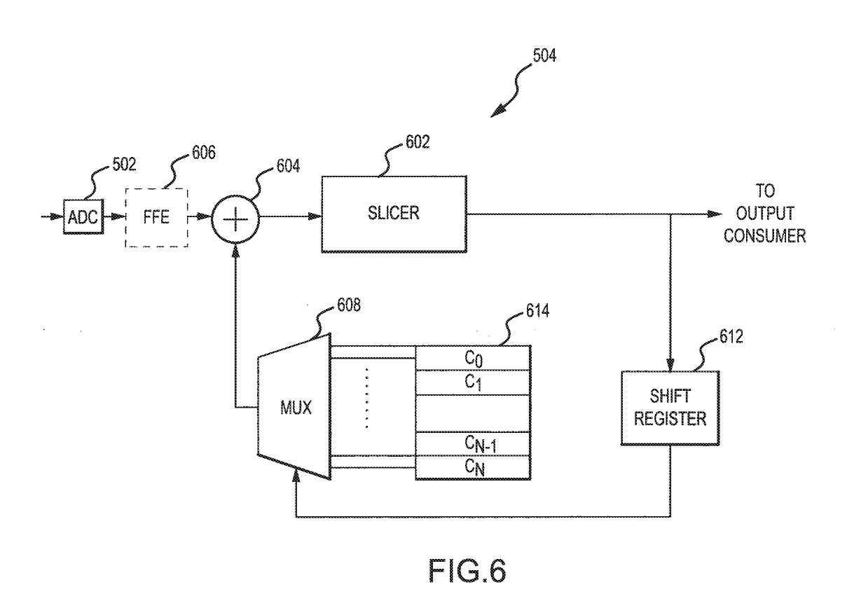

With reference to FIG. 6, there is shown a more detailed block diagram for an output determination circuit 504 in accordance with one or more embodiments. As an example, the output determination circuit 504 may be part of the receiver 404 shown in FIGS. 4 and 5. The output determination circuit 504 may include an optional feed forward equalizer (FFE) 606 that receives a symbol stream from an ADC 502. The FFE 606 may be operative to minimize pre-cursor ISI (i.e., ISI due to previously sent symbols). Additionally, the output determination circuit 504 may include a decision feedback equalizer (DFE) that includes a shift register 612, a multiplexer 608, and a set of N tap group values C0-CN (or coefficients) stored in a register 614 coupled to the multiplexer 608. In operation, the shift register 612 receives a decision symbol stream (i.e., digital 1's and 0's) from a slicer 602 and performs decision feedback equalization to generate a DFE output. In this regard, an appropriate tap group value C is selected dependent upon the decisions made by the slicer 602 for one or more previous symbols. For example, if the DFE utilizes 5-taps (thereby compensating for post-cursors h1-h5), particular tap values may be selected dependent upon the previous five symbols determined by the slicer 602. The FFE and DFE outputs may be added by an adder 604 to generate an equalizer output that is fed to the slicer 602. The decision symbol stream is generated by the slicer 602 slicing the equalizer output. The term “slice” refers to the process of selecting an allowable symbol value (i.e., a digital 1 or a digital 0) that is nearest to that of the output signal equalizer output. Although a specific output determination circuit 504 is shown in FIG. 6, it will be appreciated that other suitable implementations may be used as well.

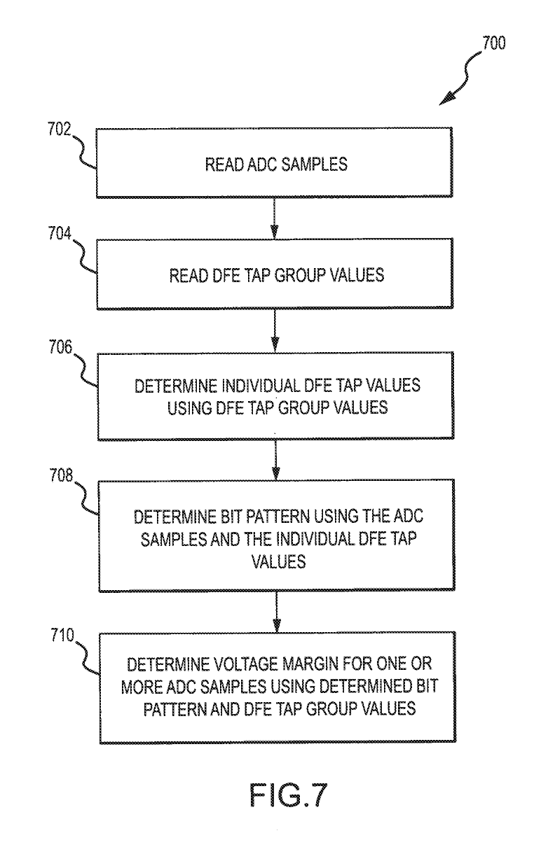

FIG. 7 illustrates a flow chart of a process 700 for determining voltage margin for a receiver in a high speed communications system. As an example, the process 700 may be realized using software (e.g., by having the processor 412 shown in FIG. 4 execute the voltage margin monitoring code 416). As an alternative, the functionality of the process 700 may also be realized in hardware, for example, by way of an ASIC or a set of hardwired logic components. This and other alternative implementations of the process 700 are within the scope of the present embodiments.

Generally, the process 700 involves reading a plurality of ADC sample values received by a receiver, identifying a highly probable bit pattern (digital 1's and 0's) for those sample values, applying ISI compensation based on the highly probable bit pattern, and determining a voltage margin. More specifically, the process 700 includes reading ADC samples from an ADC of a receiver (step 702). For example, the ADC samples may be read from the sample registers 508 shown in FIG. 5. Each of the ADC samples may be an n-bit digital number that corresponds to a voltage level received at a receiver. For example, each ADC sample may be a 4-bit digital value that represents a voltage level between −6.5 LSB and +6.5 LSB. Of course, other suitable values and ranges may be used as desired. In general, the number of ADC samples read may be selected dependent upon the number of taps in a DFE, number of taps in an FFE, the number of voltage margin calculations desired for each iteration of the process 700, or other considerations.

Next, the process 700 includes reading tap group values (or DFE compensation values) for a DFE of a receiver (step 704). For example, the tap group values may be read from the storage 414 shown in FIG. 4. Each tap group value may correspond to a particular DFE compensation to be applied to an ADC sample value dependent on previously received samples. As described above with reference to FIG. 6, a particular tap group value may be applied to an ADC sample to reduce the effects of ISI due to previous sample values. For example, in the case of a 5-tap DFE, each tap group value may relate to a compensation value for a particular 5-bit pattern (e.g., one tap group value for the 5-bit pattern 00000, another tap group value for the 5-bit pattern 10101, and the like). Continuing with the 5-tap DFE example, there may be 2⁵ or 32 possible tap group values corresponding to the possible 5-bit patterns, although there may be repetitive values due to symmetry.

Once the DFE tap group values have been read, the individual tap values h for the DFE may be determined (step 706). Since each of the tap group values C correspond to the individual tap weights h for a particular bit pattern, a matrix equation may be solved for the individual tap values h using the previously read tap group values C and the bit patterns for the individual tap values.

Next, the process 700 may include determining a bit pattern for the plurality of ADC samples using the magnitudes of the ADC samples and the individual DFE tap values (step 708). For example, this step may include comparing each ADC sample to one or more threshold values, comparing ADC samples with each other, applying individual DFE tap values to the ADC samples, and the like. The result of this step is to provide a highly probable bit pattern for the ADC samples read. For example, in the case where the plurality of ADC samples includes 5 samples, the output of this step may be a bit pattern such as 10010, or the like. It should be appreciated that for some groups of ADC samples, it may not be possible to determine a bit pattern with a relatively high probability. In these cases, the process 700 may throw out a set of ADC samples and restart the process with a fresh set of ADC samples.

Once a highly probable bit pattern has been determined, the voltage margin for one or more of the bits may be calculated using the determined bit pattern, the magnitude of the ADC sample for the bit being tested, and the DFE tap group values that were previously determined (step 710). As can be appreciated, in an ideal communications link, the magnitude of a symbol read by a receiver would measure the cursor pulse (h0). Therefore, using the voltage margin calculation, a system may monitor the voltage margin over a period of time to determine its deviation from h0 and/or whether the voltage margin is changing over time. As an example, a changing voltage margin may be indicative of mechanical or electrical problems with the communications link. As can be appreciated, users of a system may wish to further inspect, repair, or replace systems that have degraded voltage margin such that reductions in performance may be reduced.

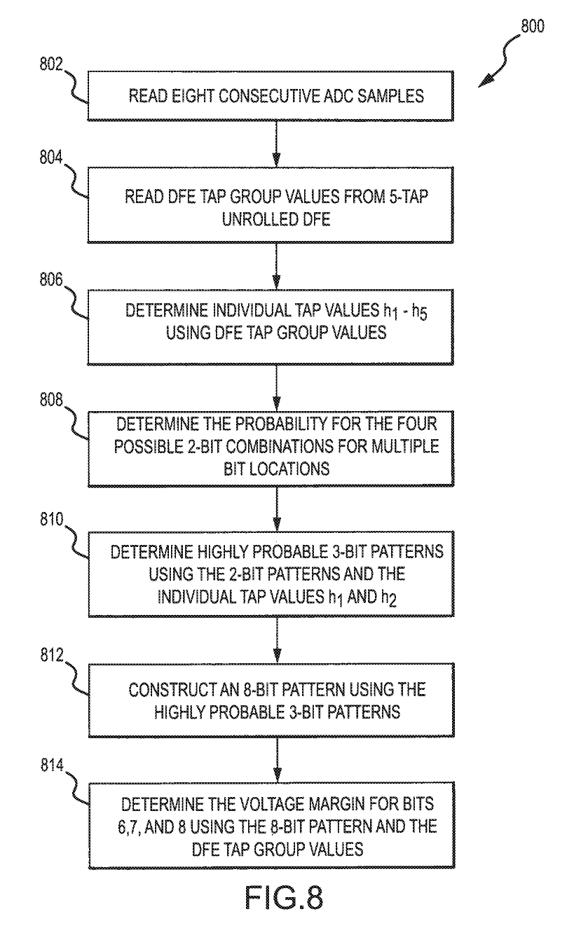

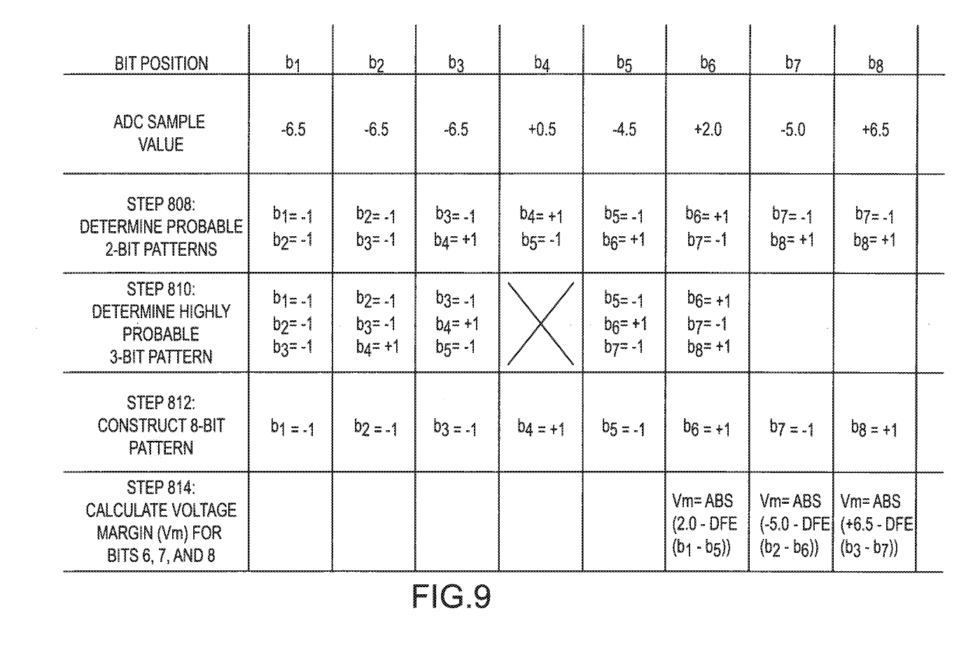

FIGS. 8 and 9 illustrate a process 800 (FIG. 8) and a table (FIG. 9) for performing a voltage margin calculation in a receiver in a high speed communications system. In general, the process 800 is a specific embodiment of the process 700 shown in FIG. 7. Similar to the process 700, the process 800 may be realized using software (e.g., by having the processor 412 shown in FIG. 4 execute the voltage margin monitoring code 416). As an alternative, the functionality of the process 800 may also be realized in hardware, for example, by way of an ASIC or a set of hardwired logic components. This and other alternative implementations of the process 800 are within the scope of the present embodiments.

The process 800 begins by reading eight consecutive ADC samples from an ADC of a receiver (step 802). In the table shown in FIG. 9, these ADC samples correspond to eight bits b1-b8. The ADC samples are 4-bit values that represent voltage levels that range from −6.5 LSB to +6.5 LSB. As can be seen, the ADC sample values for bits b1-b8 are −6.5, −6.5, −6.5, +0.5, −4.5, +2.0, −5.0, and +6.5, respectively.

In this example, the receiver system includes a 5-tap DFE that is operative to compensate for ISI due to the five previously sent symbols. That is, for bit b6, the DFE will compensate for ISI due to bits b1-b5. Similarly, for bit b7, the DFE will compensate for ISI due to bits b2-b6. Similar to the DFE shown in FIG. 6, the DFE in this example includes a plurality of tap group values, each tap group value corresponding to a compensation value for a particular 5-bit pattern. For example, there may be one tap group value C for the 5-bit combination +1, +1, −1, +1, and −1, and another tap group value for the 5-bit combination +1, −1, −1, +1, and +1. As can be appreciated, each tap group value for a particular bit pattern comprises a weighted sum of individual tap values h1-h5 for each bit in a particular bit combination.

The process 800 includes reading the DFE tap group values from the 5-tap unrolled DFE (step 804) and determining individual tap values h1-h5 using the DFE tap group values. As noted above, step 804 may be performed by solving a set of linear equations which equate the set of DFE tap group values to a linear combination of tap values h1-h5.

The process 800 also includes determining the probability for the four possible 2-bit combinations (i.e., 00, 11, 01, and 10) for pairs of the various bit positions b1-b8 to begin to construct a highly probably 8-bit pattern (step 808). In this example, the nominal value for a digital 1 is +4.5 LSB, and the nominal value for a digital 0 (also represented by a −1) is −4.5 LSB. Of course, other values may be used in other configurations. In this step, each of the ADC sample values is compared with +4.5 and −4.5. If an ADC sample value is greater than +4.5, that sample is assigned the bit value of +1. Conversely, if an ADC sample value is less than −4.5, that sample is assigned the bit value of −1 (or a digital 0). It is noted that these assignments are reasonable because the ISI required to affect a symbol so greatly that a bit value of −1 is measured at greater than +4.5 (or a bit value of +1 is measured at less than −4.5) is highly improbable. As a result of this comparison, bits b1, b2, and b3 are assigned to a value of −1, and bit b8 is assigned to a value of +1. In addition to comparing the individual magnitudes of the ADC sample values, the difference between adjacent ADC samples is also compared. That is, if the difference between an ADC sample and a previous ADC sample is greater than +4.5, then the 2-bit pattern −1, +1 is assigned to the bits being compared. Similarly, if the difference between a sample and a previous sample is less than −4.5, the 2-bit pattern +1, −1 is assigned to the bits being compared. The results of this step are shown in the table of FIG. 9. As can be seen, in this example, all eight bit positions b1-b8 have been assigned a value. It should be appreciated that for some groups of ADC sample values, probable 2-bit patterns may not be determined for every bit in the group. In these cases, the process may throw out the eight ADC samples and restart with a new set of samples.

Once the probable 2-bit patterns have been constructed, highly probable 3-bit patterns may be determined (step 810). To construct each 3-bit pattern, an ADC sample is compared to −4.5 and +4.5 as in step 808, except that the ISI information for the previous two bits (i.e., h1 and h2) is utilized in addition to the ADC sample value. For example, for bit b5, the ADC sample value (−4.5) and the ISI information for bits b3 and b4 (i.e., h1 for bit b4 and h2 for bit b3) are compared to the reference values −4.5 and +4.5. In this regard, the 2-bit patterns determined in step 808 and the individual tap values h1 and h2 are used to construct multiple, highly probable 3-bit patterns. As with the 2-bit patterns, for some groups of ADC samples, it may not be possible using the process 800 to construct 3-bit patterns that cover all eight bits b1-b8. In these cases, the process 800 may throw out the eight ADC samples and restart with a new set of samples.

Next, the process 800 may construct highly probable 8-bit pattern using the sets of 3-bit patterns by stitching the 3-bit patterns together (step 812). The result of this step is shown in the table of FIG. 9. Once the bit values for all eight bits b1-b8 have been determined, the voltage margin for bits b6, b7, and b8 may be calculated using the ADC sample value for each bit and the DFE tap group values (step 814). The results of this step are shown in the table of FIG. 9. As can be seen, the voltage margin Vm for bit b6 is determined by solving for the magnitude of the ADC sample for bit b6 (i.e., +2) minus the ISI information for bits b1-b5 (i.e., the DFE tap group value for the bit pattern −1, −1, −1, +1, and −1, which corresponds to the determinations made for bits b1-b5). Similarly, the voltage margin Vm for bits b7 and b8 may be calculated using the ISI information for bits b2-b6 and bits b3-b7, respectively. It should be appreciated that in systems that include a feed forward equalizer (FFE) in addition to a DFE, the FFE compensation may need to be included in the voltage margin calculation as well.

As noted above, an ideal voltage margin value in this example would be 4.5, which corresponds to the magnitude of an ideal voltage pulse (h0). However, in practice the actual voltage margin may differ from this ideal due to various approximations and system imperfections. Once determined, the voltage margin may then be periodically calculated and monitored to detect potential problems with the receiver and/or communications link. The monitoring may include any type of monitoring, including statistical analysis of the voltage margin over time. Additionally, the monitoring may provide alerts to system operators to provide an indication of reduced performance or failure of the system. Those skilled in the art will readily recognize other ways in which the determined voltage margins may be used by a system.

While this specification contains many specifics, these should not be construed as limitations on the scope of the disclosure or of what may be claimed, but rather as descriptions of features specific to particular embodiments of the disclosure. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

We claim:

1. A computer-implemented method for measuring voltage margin in a serial communications link, the method comprising:
receiving a plurality of ordered digital values from an analog to digital converter (ADC) of a receiver, each digital value corresponding to a voltage level sampled by the ADC at a time interval that corresponds to a symbol sent by a transmitter;
determining bit values for each of the digital values;
determining intersymbol interference (ISI) information for at least one of the determined bit values; and
calculating voltage margin for the at least one of the bit values using the digital value from the ADC corresponding to the bit value and subtracting the determined ISI for the bit value.

2. The method of claim 1, wherein the determining bit values step comprises comparing the digital values to a reference value.

3. The method of claim 1, wherein the step of determining bit values comprises comparing at least one of the ordered digital values with an adjacent digital value.

4. The method of claim 1, wherein the ISI information is obtained from at least one of a feed forward equalizer and a decision feedback equalizer (DFE).

5. The method of claim 1, wherein the determining ISI information comprises retrieving a plurality of tap group values for an unrolled decision feedback equalizer (DFE) and determining individual tap values based on the tap group values.

6. The method of claim 1, wherein the determining bit values step further comprises:
comparing the digital values to a reference value;
comparing at least one of the ordered digital values with an adjacent digital value; and
applying ISI compensation to the digital values;
comparing the ISI-compensated digital values to a reference value.

7. The method of claim 1, wherein the calculating voltage margin step includes applying feed forward equalization (FFE) compensation.

8. The method of claim 1, further comprising:
monitoring the voltage margin for the communication for a period of time.

9. The method of claim 8, wherein the monitoring step includes analyzing the voltage margin for the communication link using statistical analysis.

10. A computer system, comprising:
a processor; and
a data storage coupled to the processor, the data storage storing a voltage margin monitoring module that is operative to be executed by the processor to:
receive a plurality of ordered digital values from an analog to digital converter (ADC) of a receiver, each digital value corresponding to a voltage level sampled by the ADC at a time interval that corresponds to a symbol sent by a transmitter;
determine bit values for each of the digital values by comparing the digital values to a reference value;
determine intersymbol interference (ISI) information for at least one of the determined bit values; and
calculate voltage margin for the at least one of the bit values using the digital value from the ADC corresponding to the bit value and subtracting the determined ISI for the bit value.

11. The computer system of claim 10, wherein the voltage margin monitoring module is further operative to be executed by the processor to determine bit values by comparing at least one of the ordered digital values with an adjacent digital value.

12. The computer system of claim 10, wherein the ISI information is obtained from at least one of a feed forward equalizer (FFE) and a decision feedback equalizer (DFE).

13. The computer system of claim 10, wherein the voltage margin monitoring module is further operative to be executed by the processor to determine ISI information by retrieving a plurality of tap group values for an unrolled decision feedback equalizer (DFE) and determining individual tap values based on the tap group values.

14. The computer system of claim 10, wherein the voltage margin monitoring module is further operative to be executed by the processor to determine bit values by:
comparing the digital values to a reference value;
comparing at least one of the ordered digital values with an adjacent digital value;
applying ISI compensation to the digital values; and
comparing the ISI-compensated digital values to a reference value.

15. The computer system of claim 10, wherein the calculating voltage margin step includes applying feed forward equalization (FFE) compensation.

16. The computer system of claim 10, further comprising:
monitoring the voltage margin for the communication for a period of time.

17. The computer system of claim 16, wherein the monitoring step includes analyzing the voltage margin for the communication link using statistical analysis.

18. A computer readable medium, with instructions which when processed by a computer cause the computer to:
receive a plurality of ordered digital values from an analog to digital converter (ADC) of a receiver, each digital value corresponding to a voltage level sampled by the ADC at a time interval that corresponds to a symbol sent by a transmitter;
determine bit values for each of the digital values;
determine intersymbol interference (ISI) information for at least one of the determined bit values by utilizing information received from a decision feedback equalizer (DFE); and
calculate voltage margin for the at least one of the bit values using the digital value from the ADC corresponding to the bit value and subtracting the determined ISI for the bit value.

19. The computer readable medium of claim 18, wherein the instructions are further operative to, when processed by a computer, cause the computer to:
determine bit values by comparing at least one of the ordered digital values with an adjacent digital value.

20. The computer readable medium of claim 18, wherein the instructions are further operative to, when processed by a computer, cause the computer to:
retrieve the ISI information from at least one of a feed forward equalizer (FFE) and a decision feedback equalizer (DFE).
